(19) United States
(12) Patent Application Publication
(10) Pub. No.: US 2014/0236621 A1
(43) Pub. Date: Aug. 21, 2014

(54) METHOD FOR DETERMINING A PREDICTIVE FUNCTION FOR DISCRIMINATING PATIENTS ACCORDING TO THEIR DISEASE ACTIVITY STATUS

(71) Applicants: Centre National de la Recherche Scientifique (CNRS), Paris (FR); Universite Pierre Et Marie Curie (Paris 6), Paris (FR)

(72) Inventors: Adrien Six, Arcueil (FR); Wahiba Chaara, Asnieres-sur-Seine (FR); David Klatzmann, Paris (FR); Yves Allenbach, Paris (FR); Olivier Benveniste, Paris (FR); Patrice Cacoub, Le Perreux (FR); David Saadoun, Neuilly-sur-Seine (FR); Benjamin Terrier, Paris (FR)

(73) Assignees: UNIVERSITE PIERRE ET MARIE CURIE (PARIS 6), Paris (FR); Centre National de la Recherche Scientifique (CNRS), Paris (FR)

(21) Appl. No.: 14/347,089

(22) PCT Filed: Sep. 26, 2012
(86) PCT No.: PCT/EP2012/068976

§ 371 Date: Mar. 25, 2014

(30) Foreign Application Priority Data
Sep. 26, 2011 (EP) 11306223.6

(51) Int. Cl. G06F 19/00

(52) U.S. Cl. CPC G06F 19/3437
USPC 705/2

(57) ABSTRACT

The invention relates to a method for determining a predictive function for discriminating patients according to their disease activity status, comprising steps of: a—measuring values of biological markers for each patient of a first group of patients having a first known disease activity status, and for each patient of a second group of patients having a second known disease activity status, the measured values forming a dataset b—analyzing the dataset for identifying biological markers which are differentially expressed between the first group of patients and the second group of patients, c—among the biological markers identified at step b, determining correlated markers as markers which are correlated with other markers above a predetermined significance level, d—removing from the dataset, values measured for a biological marker identified as correlated marker, e—analyzing the dataset obtained at step d for determining a predictive function that predicts a disease activity status of a patient as a combination of values of biological markers, f—evaluating an accuracy index associated with the predictive function determined at step e, g—repeating steps d to f by selectively removing from the dataset, values measured for one or several biological marker(s) identified as correlated marker(s), so as to gradually decrease the number of biological markers in the combination of value until the accuracy index reaches an expected level.

### FIELD OF THE INVENTION

The invention relates to a method for determining a predictive function for discriminating patients according to their disease activity status.

### BACKGROUND OF THE INVENTION

Current high throughput technologies allow researchers to conduct millions of chemical, genetic or pharmacological tests in a very short time. For instance, these technologies provide means to quickly and easily measure values of numerous biological markers.

Based on data collected from these measurements, the researchers attempt to identify biological markers, such as genes or blood biological markers, which are involved in particular biological processes. In particular, identification of biological markers may help diagnosing pathologies or monitoring disease activity status of patients.

However, the amount of data which can possibly be collected from patients is so high that it may be difficult, in practice, to determine the most relevant biological marker(s) for a given pathology.

In addition, in some cases, it can appear that information provided by a unique biological marker is not relevant when taken alone, and need to be combined with information on other biological markers, in order to provide meaningful indication on the status of the patient. Conversely, increasing the number of biological markers in a screening assay, by taking into consideration biological markers which are not relevant, may decrease the sensitivity of the diagnosis.

In practice, the number of biological markers chosen for diagnosing or monitoring a particular pathology is at the discretion of the operator who makes the test and the biological markers measured are chosen based upon their individual predictive value or suspected predictive value for the condition(s) being diagnosed.

Most of the assays are often limited to a single biological marker or analyte per condition to be screened.

### SUMMARY OF THE INVENTION

One aim of the invention is to provide a method for discriminating patients according to their disease activity status, which minimizes the number of measured biological markers needed.

This problem is solved according to the invention by a method for determining a predictive function for discriminating patients according to their disease activity status, comprising steps of:

a—measuring values of biological markers for each patient of a first group of patients having a first known disease activity status, and for each patient of a second group of patients having a second known disease activity status, the measured values forming a dataset

b—analyzing the dataset for identifying biological markers which are differentially expressed between the first group of patients and the second group of patients,

c—among the biological markers identified at step b, determining correlated markers as markers which are correlated with other markers above a predetermined significance level,

d—removing from the dataset, values measured for a biological marker identified as correlated marker,

e—analyzing the dataset obtained at step d for determining a predictive function that predicts a disease activity status of a patient as a combination of values of biological markers,

f—evaluating an accuracy index associated with the predictive function determined at step e,

g—repeating steps d to f by selectively removing from the dataset, values measured for one or several biological marker(s) identified as correlated marker(s), so as to gradually decrease the number of biological markers in the combination of value until the accuracy index reaches an expected level.

The “expected level” can be defined as a level at which the accuracy is maximal (i.e. it is not possible to further improve the accuracy of the predictive function by removing values of biological marker(s) from the dataset).

Alternatively, the “expected level” can be defined as a threshold which is set in advance for the accuracy index. It is to be noted that when several accuracy indexes are used, several corresponding thresholds can be set (one threshold for each accuracy index).

By repeating steps d to f, the proposed method allows to reduce the number of biological markers needed for discriminating patients to its minimum, while at the same time, improving or maintaining accuracy of the predictive function.

The result of the proposed method is:
a restricted set of biological markers (called “signature”) which is relevant for discriminating patients according to their disease activity status, and
an associated predictive function for determining a predictive score from the signature, so as to discriminate patients according their disease activity status.

In the context of the present invention, “patient” or “subject” preferably intends to designate a mammal, more preferably a human. The mammal can be a human, non-human primate, mouse, rat, dog, cat, horse, or cow, but are not limited to these examples. Mammals other than humans can be advantageously used as subjects that represent animal models for a given pathology.

“Biological marker(s)” intends to mean a physiological variable measured to provide data relevant to a patient or a subject.

Biological markers can be measured from a biological sample obtained from a patient or subject. The biological sample can be any bodily fluid. For example, the biological sample can be peripheral blood, sera, plasma, ascites, urine, cerebrospinal fluid (CSF), sputum, saliva, bone marrow, synovial fluid, aqueous humor, amniotic fluid, cerumen, breast milk, broncheoalveolar lavage fluid, semen (including prostatic fluid), Cowper's fluid or pre-ejaculatory fluid, female ejaculate, sweat, fecal matter, hair, tears, cyst fluid, pleural and peritoneal fluid, pericardial fluid, lymph, chyme, chyle, bile, interstitial fluid, menses, pus, sebum, vomit, vaginal secretions, mucosal secretion, stool water, pancreatic juice, lavage fluids from sinus cavities, bronchopulmonary aspirates or other lavage fluids. A biological sample may also include the blastocyl cavity, umbilical cord blood, or maternal circulation which may be of fetal or maternal origin. The biological sample may also be a tissue sample or biopsy.

Thus, the terms “biological marker(s)” intend to encompass without limitation metabolites, carbohydrate, lipids, proteins (or polypeptides or peptides which terms are used interchangeably), nucleic acids, together with their polymorphisms, mutations, variants, modifications, subunits, fragments, protein-ligand complexes, and degradation products, and other analytes or sample-derived measured values.

Physical values such as heart rate or blood pressure can be included as biological markers.

A number of suitable methods can be used to identify, detect and/or quantify the biological markers values included in the method of the present invention. For example, the measurements of the level of these biological markers can be obtained separately for individual biological markers, or can be obtained simultaneously for a plurality of biological markers.

Any suitable technology including, for example, single assays such as ELISA or PCR can be used.

An example of a platform useful for multiplexing is the flow-based Luminex assay system. This multiplex technology uses flow cytometry to detect antibody/peptide/oligonucleotide or receptor tagged and labelled microspheres.

Other various methods well known by the skilled person can be used for measurement of such biological markers, such as the use of DNA, protein or antibody arrays to identify or quantify nucleic acid, polypeptide (or functional fragment thereof) biomarker(s), as well as other array, Sequencing, PCR and proteomic techniques known in the art for identification and assessment of nucleic acid and polypeptide/protein molecules.

According to an embodiment of the invention, the method comprises a step of:

h—replacing missing values by default values in the dataset before carrying out step b.

In particular, step h can be performed for each biological marker having less than a predetermined rate of missing values per group.

For a given biological marker, default values can be randomly drawn from a uniform distribution comprised between 0 and a detection threshold associated with measurement of the biological marker. Other such methods for replacing missing values are well known from the skilled persons.

According to an embodiment of the invention, the method comprises a step of:

i—normalizing the measured values of the dataset, so that step b is carried out on a normalized dataset.

Step i can be performed by subtracting a mean value to the value to be normalized and dividing by a standard deviation, the mean value and the standard deviation being determined for each group of patients.

Moreover, the values of the dataset can be log 10 transformed before normalization.

According to an embodiment of the invention, step b comprises:

j—applying a statistical test to the dataset for determining, for each biological marker, a probability that, given the dataset, the biological marker is found to be differentially expressed while not differentially expressed between the two groups of patients,

k—selecting biological markers having a probability equal or lower than the predetermined significance level.

Step b can also comprise:

l—applying a false discovery rate correction to each probability and carrying out step k on each corrected probability associated with a given biological marker.

The statistical test can be a parametric test such as a Student test.

At step l, each corrected probability can be obtained by applying Benjamini-Hochberg False Discovery Rate correction to each probability.

According to an embodiment of the invention, the predictive function is a linear combination of values of the biological markers.

In particular, step e is performed by Linear Discriminant Analysis of the dataset obtained at step d.

According to an embodiment of the invention, the accuracy index associated with a predictive function is obtained by using a Leave-One-Out cross-validation method.

According to an embodiment of the invention, the accuracy index is derived from a prediction error rate, a sensitivity, a specificity, a positive predictive value and/or a negative predictive value associated with the predictive function determined at step e.

According to an embodiment of the invention, the biological markers are selected from the group consisting of blood biological markers, preferably which can be measured from whole blood sample, more preferably from blood cells and/or serum and/or plasma sample.

In particular, the biological markers can comprise protein levels, preferably cytokine or chemokine levels.

According to an embodiment of the invention, the first known disease activity status and the second known disease activity status are active disease and inactive disease or disease in remission.

According to an embodiment of the invention, the disease is selected from the group consisting of autoimmune diseases and inflammatory diseases.

The invention also relates to a method for discriminating patients according to their disease activity status, comprising steps of:

m—measuring values of biological markers for a patient who's disease activity status is unknown, and

n—applying a predictive function as a combination of the measured values, and

o—determining the disease activity status of the patient depending on a result of the predictive function,

wherein the predictive function has been determined according to the method as defined previously.

The “disease activity status” of a patient or a subject can be used to evaluate diagnostic criteria such as presence of disease, disease staging, disease monitoring, disease stratification, or surveillance for detection, metastasis or recurrence or progression of disease. Said activity status can also be used clinically in making decisions concerning treatment modalities including therapeutic intervention or treatment decisions, including whether to perform surgery or what treatment standards should be utilized along with surgery. Said disease activity status can also avoid the need for more invasive tests that present a risk for the health of the patient, such as intramuscular activity evaluation, internal organ biopsy, lumbar puncture.

The disease activity status of a patient or a subject can also be used in therapy related diagnostics to provide tests useful to diagnose a disease or choose the correct treatment regimen, such as provide a theranosis (theranostics includes diagnostic testing that provides the ability to affect therapy or treatment of a diseased state).

In a preferred embodiment, the present invention also encompasses a method for producing a transmittable form of information on the disease activity status of one or more patients, said method comprising the steps of (1) determining the disease activity status of one or more patient(s) according to methods of the present invention; and (2) embodying the result of said determining step into a transmittable form.

In one embodiment, a computer-readable medium includes a medium suitable for transmission of a result of an analysis of the disease activity status of one or more patients. The medium can include:
the results regarding the values of biological markers measured for one or more patients who's disease activity status is desired to be known, and
the activity status of said patient(s) obtained after applying the predictive function for the minimized biological markers combination to the measured values.

The invention also relates to an in vitro method for determining the activity status of the Takayasu Arteritis disease in a patient from a sample of said patient comprising the steps of:

a) measuring the expression of IL-1RA, IL-2, IL-4, IL-8, IL15, IL-17, TNF-α, GM-CSF and MIP-1β in said sample; and

b) determining the activity status of the patient by correlating the measurement obtained in step a) with the activity status of the Takayasu Arteritis disease, preferably by implementing the method for discriminating patients for said disease.

The invention also relates to a method for determining the activity status of the Giant Cells Arteritis disease in a patient from a sample of said patient comprising the steps of:

a) measuring the expression IL-2R, IL-12, IFN-γ, IL-17 and GM-CSF in said sample; and

b) determining the activity status of the patient by correlating the measurement obtained in step a) with the activity status of the Giant Cells Arteritis disease, preferably by implementing the method for discriminating patients for said disease.

The invention also relates to an in vitro method for determining the activity status of the Sporadic Inclusion Body Myositis disease in a patient from a sample of said patient comprising the steps of:

a) measuring the expression IL-1RA, IL-8, IL-12, CCL-2 (MCP-1), CCL-3 (MIP-1α), CXCL-9 (MIG), and CXCL-10 (IP-10) in said sample; and

b) determining the activity status of the patient by correlating the measurement obtained in step a) with the activity status of the Sporadic Inclusion Body Myositis disease, preferably by implementing the method for discriminating patients for said disease.

The invention also relates to a method for determining the activity status of the Behçet's disease in a patient from a sample of said patient comprising the steps of:

a) measuring the expression of IL-17, TNF-A, IL-23 and IL-21 in said sample; and

b) determining the activity status of the patient by correlating the measurement obtained in step a) with the activity status of the Behçet's disease, preferably by implementing the method for discriminating patients for said disease.

The invention also relates to a method for determining the activity status of the Hepatitis C Virus in a patient from a sample of said patient comprising the steps of:

a) measuring the expression CD27, Gglob, IL-2R and C4 in said sample; and

b) determining the activity status of the patient by correlating the measurement obtained in step a) with the activity status of the Hepatitis C Virus, preferably by implementing the method for discriminating patients for said virus.

### DESCRIPTION OF THE FIGURES

The invention will be described with reference to the drawings, in which:

FIG. 1 is a flow diagram showing different steps of a method for determining a predictive function according to an embodiment of the invention,

FIG. 2 is a flow diagram showing different steps of the method for discriminating patients according to their disease activity status according to an embodiment of the invention,

FIG. 3 is a diagram illustrating Pearson correlation coefficients rₚ between differentially expressed biological markers,

FIG. 4 is a diagram illustrating a hierarchical classification on signatures that discriminate patients with active and inactive Takayasu arteritis,

FIG. 5 is a diagram illustrating a hierarchical classification on signatures that discriminate patients with active and inactive Giant cell arteritis (Horton disease),

FIG. 6 is a diagram obtained when Takayasu signature is applied to Horton patient dataset,

FIG. 7 is a diagram illustrating a hierarchical classification on signatures that discriminate patients with active Sporadic Inclusion Body Myositis and healthy patients (controls),

FIG. 8 is a diagram illustrating a PCA projection using the 4 cytokines selected by ANOVA statistical test,

FIG. 9 is a diagram illustrating a hierarchical classification on signatures that discriminate patients with active Hepatitis C virus (patients with no lymphoma) and patients with inactive Hepatitis C virus (patients with lymphoma),

FIG. 10 shows the distribution of LDA coefficients of the prediction function obtained for Hepatitis C virus and the associated prediction errors.

### DESCRIPTION OF THE PREFERRED EMBODIMENTS

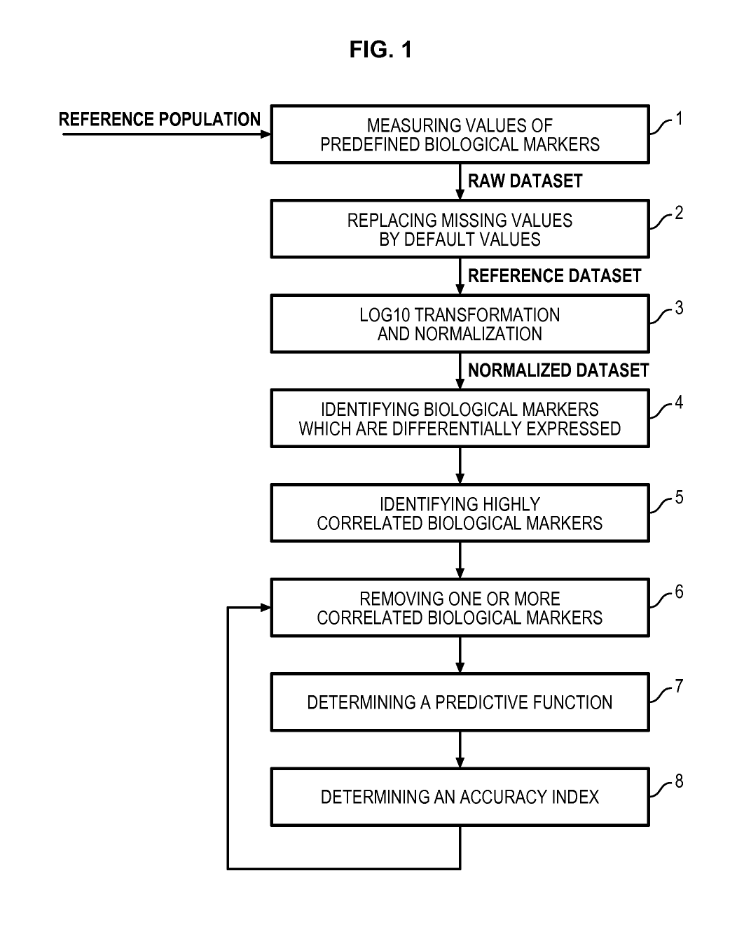

FIG. 1 shows different steps of a method for determining a predictive function for discriminating patients according to their disease activity status for a given disease, such as an autoimmune disease for instance.

The method is based on a reference population, the reference population including a plurality of individuals (N patients) whose disease activity status is known.

More precisely, the reference population comprises of a first group of patients having a first known disease activity status (active disease) and a second group of patients having a second known disease activity status (disease in remission).

According to a first step 1, values of predefined biological markers are measured for each patient of the first group and for each patient of a second group.

In this workflow, a blood sample is taken from each patient and the blood sample is analyzed in order to detect a level of each biological marker in the blood sample.

Biological markers which are measured are selected from the group consisting of blood biological markers, preferably which can be measured from whole blood sample, more preferably from blood cells and/or serum and/or plasma sample.

This step leads to obtaining a raw dataset comprised of measured values of biological markers for each patient of the reference population. The measured values of the raw dataset are stored in a digital memory or in a database in view of being processed by a computer system.

However, it is to be noted that the raw dataset may comprise missing values.

Missing values can be due to an absence of measurement on the biological marker for some patients during data collection.

This can also be due to failure to detect a signal when the biological marker is not present at a sufficient level in the blood sample, i.e. the biological marker is present at a level lower than a detection threshold associated with measurement of the biological marker.

Processing of the dataset is carried out by a computer system, which is programmed for automatically executing the following steps.

According to a second step 2, for each biological marker having less than 60% missing values per group, missing values are replaced by default values in the raw dataset so as to build a complete reference dataset.

According to a first possibility, when missing values are due to an absence of measurement, default values are computed on existing measurements. For instance default values can be computed by a k-nearest neighbor (k−NN) algorithm. For each sample with a missing value, the algorithm finds the k-nearest neighbors using a Euclidian metric, confined to the samples for which the value is not missing. The parameter k can be set to 5. Having found the k-nearest samples, a default value is determined as a mean of non-missing values corresponding to the same biological marker in the k nearest samples. This method leads to ignore biological markers with a lot of missing values per group.

If missing values are due to undetected signal, default values are drawn from a uniform distribution comprised between 0 and a detection threshold associated with measurement of the biological marker. This method allows taking into account factors which are not expressed in all groups.

According to a third step 3, the values of the reference dataset are log 10 transformed and normalized, so as to obtain a normalized reference dataset.

For each group of patients, a mean value and a standard deviation is determined.

Each value of the reference dataset is normalized by subtracting the mean value to the value to be normalized and dividing by the standard deviation.

This step allows obtaining a homogeneous dataset from an heterogeneous dataset composed by factors of different nature possible.

According to a fourth step 4, the normalized dataset is analyzed for identifying biological markers which are differentially expressed between the first group of patients and the second group of patients.

To this end, a statistical test is applied to the normalized dataset for determining p-values, each p-value being associated with a given biological marker.

A parametric or non-parametric statistical test can be used depending on the type and amount of data available. A parametric test is used when data are drawn from a known distribution, while non-parametric test makes no assumption about the underlying distribution of data.

Preferably, the statistical test applied is a parametric test such as the Student test.

Reference is made to Biometrika, 6 (1908), pp. 1-25, reprinted on pp. 11-34 in “Student's” Collected Papers, Edited by E. S. Pearson and John Wishart with a Foreword by Launce McMullen, Cambridge University Press for the Biometrika Trustees, 1942.

The dataset comprises two groups of samples having respective sizes of N₁ and N₂ corresponding to the two groups of patients.

In the first group of patients, the mean value measured for a given biological marker Xᵢ is x̅ᵢ¹ and the standard deviation is σᵢ¹. In the second group of patients, the mean value measured for the same biological marker Xᵢ is x̅ᵢ² and the standard deviation is σᵢ².

The hypotheses which are tested are the following:
Hypothesis H0: the biological marker Xᵢ is not differentially expressed:

x̅ᵢ¹= x̅ᵢ² and σᵢ¹=σᵢ²
Hypothesis H1: the biological marker Xᵢ is differentially expressed:

x̅ᵢ¹≠ x̅ᵢ² and σᵢ¹≠σᵢ²

The statistics for testing whether the means of the groups are different is determined as:

$$t = \frac{{\overline{x}}_{i}^{1} - {\overline{x}}_{i}^{2}}{{σ}_{i}^{1} - {σ}_{i}^{2}}$$

The statistics follows a Student law with (N₁+N₂)−1 degrees of freedom.

For each biological marker Xᵢ, an associated p-value is determined based on the statistic t and on the degree of freedom (N₁+N₂)−1.

The p-value is the probability that, given the dataset, the hypothesis H1 is found while the biological marker Xᵢ is not differentially expressed between the two groups of patients.

Then, a correction is applied to each p-value so as to take into account a false discovery rate which depends on the total number M of biological markers under consideration.

The correction applied is preferably a Benjamini-Hochberg False Discovery Rate correction.

Reference is made to Benjamini, Y. and Hochberg, Y. (1995). “Controlling the False Discovery Rate: a Practical and Powerful Approach to Multiple Testing,” Journal of the Royal Statistical Society B, 57, 289-300.

The p-values are ranked from the smallest to the largest.

For each biological marker, a q-value is determined by:

$$q \text{-} value = p \text{-} value \times \frac{M}{R}$$

where M is the total number of biological markers, and R is the rank of the p-value associated to the biological marker.

Then, biological markers having a q-value equal or below a predetermined significance level α are selected. The significance level α is typically 0.05.

Alternatively, the correction applied can be a Bonferonni-Holm Family Wise Error Rate correction.

Reference is made to Holm, S. (1979). “A Simple Sequentially Rejective Test Procedure,” Scandinavian Journal of Statistics, 6, 65-70.

Reference is also made to Abdi H. Holm's sequential Benferroni procedure. In Encyclopedia of Research Design. Salkind N, ed. Thousand Oaks, Calif.: Sage, 2010; 1-8.

According to a fifth step 5, highly correlated biological markers are identified. Highly correlated markers are defined as markers which have an associated correlation coefficient above a predetermined threshold.

To this end, Bravais-Pearson correlations between biological markers are computed.

For a first given biological markers Xᵢ, a first series of values (xᵢ₁, xᵢ₂, . . . x_{iN}) are the values measured for the first biological marker in the N samples.

For a second biological marker Xⱼ, a second series of values (xⱼ₁, xⱼ₂, . . . x_{jN}) are the values measured for the second biological marker in the N samples.

Pearson correlation coefficient rₚ is determined as:

$${r}_{P} ( {X}_{i} , {X}_{j} ) = \frac{{\sum }_{k = 1}^{N} ( {x}_{ik} - {\overline{x}}_{i} ) \cdot ( {x}_{jk} - {\overline{x}}_{j} )}{\sqrt{{\sum }_{k = 1}^{N} {( {x}_{ik} - {\overline{x}}_{i} )}^{2}} \cdot \sqrt{{\sum }_{k = 1}^{N} {( {x}_{jk} - {\overline{x}}_{j} )}^{2}}}$$

wherein x̅ᵢ is the mean value of the series xᵢ₁, xᵢ₂, . . . x_{iN} and x̅ⱼ is the mean value of the series xⱼ₁, xⱼ₂, . . . x_{jN}.

If rₚ is equal to 0, the two series are not correlated. The two series are all the better correlated since rₚ is far from 0 and near 1 or −1.

Biological markers Xᵢ, and Xⱼ having a Pearson correlation coefficient rₚ greater than a given threshold are considered as highly correlated. More precisely, biological markers Xᵢ, and Xⱼ having a Pearson correlation coefficient rₚ greater than 0.9 or lesser than −0.9 are considered as highly correlated.

According to a sixth step 6, values corresponding to a correlated marker identified at step 7 are removed from the normalized reference dataset.

When two biological markers are found correlated, that with the highest associated p-value or q-value for differential expression between the first group and the second group of patients (i.e. the least differentially expressed) is generally that which is removed from the dataset.

According to a seventh step 7, the normalized reference dataset, wherein the values corresponding to a correlated marker have been removed, is analyzed for determining a predictive function that predicts a disease activity status of a patient as a combination of values of biological markers.

A Linear Discriminant Analysis of the normalized reference dataset obtained at step 6 is performed.

Reference is made to Fisher, R. (1936). “The use of multiple measurements in taxonomic problems.” Annals of Eugenics, 7, 179-188.

The LDA allows computing a predictive function ƒ as a linear combination of values of M′ biological markers:

$$f ( {x}_{1 k} , {x}_{2 k} , … {x}_{Mk} ) = {\sum }_{i = 1}^{M ′} {λ}_{i} {x}_{ik}$$

where λᵢ is a coefficient of the predictive function ƒ associated with biological marker i.

The predictive function ƒ assigns a predictive score to a series of values (x₁ₖ, x₂ₖ, . . . x_{Mk}) of biological markers measured for a given patient k. A predictive score equal or greater than 0 is assigned to patients having a first disease activity status (active disease) while a negative score is assigned to patients having a second activity status (disease in remission).

According to a eighth step 8, one or more accuracy indexes associated with the predictive function ƒ determined at step 7 is(are) computed.

The accuracy indexes associated with the predictive function ƒ is(are) obtained by using a Leave-One-Out cross-validation method, wherein the function ƒ is computed on a set of N−1 patients and tested with one remaining patient. The accuracy indexes is(are) determined as a function of a prediction error rate, a sensitivity (SE), a specificity (SP), a positive predictive value (PPV) and a negative predictive value (NPV) associated with the predictive function ƒ determined at step 7.

Table 1 shows the possible outcomes when measuring of the intrinsic validity of a predictive model.

TABLE 1

| | | Real class | |
|---|---|---|---|
| Disease Activity status | | Active | Inactive |
| Predicted class | Active | TP | FP |
| | Inactive | FN | TN |

TP: True Positive; FP: False Positive; FN: False Negative; TN: True Negative.

In this table, we observe that:
TP is the number of individuals with an active disease status and a positive prediction,
FP is the number of individuals with an inactive disease status but a positive prediction,
FN is the number of individuals with an active disease status but a negative prediction,
TN is the number of individuals with an inactive status and a negative prediction.

The accuracy indexes are calculated using the following formulas:

$$Predictive error rate = 1 - \frac{T P + T N}{Total}$$

$$P P V = \frac{T P}{T P + F P}$$

$$N P V = \frac{T N}{F N + T N}$$

$$S E = \frac{T P}{T P + F N}$$

$$S P = \frac{T N}{F P + T N}$$

According to a ninth step 9, steps 6 to 8 are repeated by selectively removing from the normalized reference dataset, values corresponding to one or several correlated marker(s), so as to improve the accuracy of the predictive function.

For instance, the accuracy of the predictive function is improved when the predictive error rate is decreased.

If removing values corresponding to a correlated marker causes the predictive error rate to decrease, then steps 6 to 8 are repeated by keeping said values removed, and removing additional values corresponding to another correlated marker.

Conversely, if removing values corresponding to a correlated marker causes the predictive error rate to increase, then said values are reintroduced into the normalized reference dataset, steps 6 to 8 are repeated by removing values corresponding to another correlated marker.

Other or several accuracy indexes can be used, such as the sensitivity (SE), specificity (SP), positive predictive value (PPV) or the negative predictive value (NPV). Accuracy of the predictive function is improved when one of these accuracy indexes is increased.

Step 9 is performed until it is not possible to further improve the accuracy of the predictive function, i.e. the accuracy index is optimal.

The method leads to determining:
a restricted set of M′ biological markers (signature) which is relevant for discriminating patients according to their disease activity status, and
an associated predictive function ƒ for determining a predictive score from the signature, so as to discriminate patients according their disease activity status.

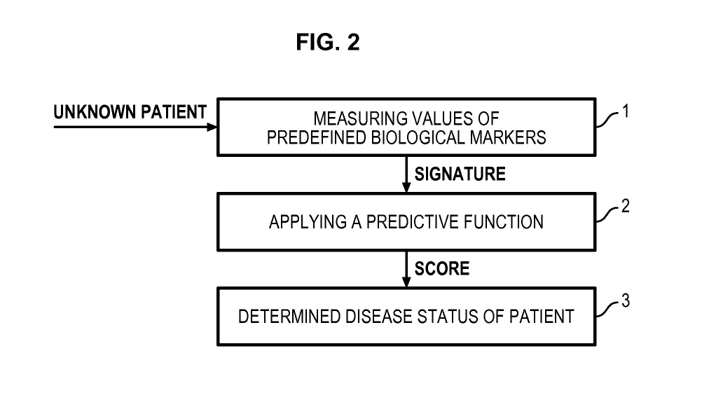

FIG. 2 shows different steps of a method for discriminating patients according to their disease activity status in connection with a given disease.

According to a first step 1, values of M predefined biological markers (x₁ₗ, x₂ₗ, . . . x_{Ml}), which are relevant for the disease, are measured for a patient/whose disease activity status is to be determined.

The measured values may be stored in a digital memory or in a database for further processing, or sent through a communication network to a distant server in view of being processed.

Processing of the measured values is performed by a computer system or server, which is programmed for reading the measured values from the digital memory or database and for carrying out the following steps.

According to a second step 2, the predictive function ƒ is applied to the measured values, so as to compute a predictive score ƒ (x₁ₗ, x₂ₗ, . . . x_{M′l}) for the patient.

According to a third step 3, an activity status is determined depending on the predictive score.

For instance, if the predictive score is equal or greater than 0, then the patient will be considered as having a first disease activity status (active disease),

Conversely, if the predictive score is negative, the patient will be considered as having a second disease activity status (disease in remission). The method allows predicting the disease activity status of the patient based on a set of measured values of biological markers (i.e. the signature).

The computer system may display information including the predictive score and/or the disease activity status of the patient.

Alternatively, the computer system may send the information including the predictive score and/or the disease activity status of the patient to a remote location, such as a healthcare center or a hospital, through a communication network.

### Example 1

### Takayasu's Arteritis

Takayasu arteritis (TA) is a large-vessel vasculitis of unknown origin. Data on predictive criteria of TA activity are lacking. One objective is to identify an immunological signature that help to discriminate active and inactive patients with TA.

Thirty TA patients (11 active untreated [aTA] and 19 treated and inactive [iTA]) fulfilling the American College of Rheumatology criteria and healthy donors (HD) were included. We measured levels of 26 cytokines (GM-CSF, IFN-α, IFN-γ, IL-1RA, IL1β, IL-2, IL-2r, IL-4, IL-5, IL-6, IL-7, IL-8, IL-10, IL-12, IL-13, IL-15, IL-17, CXCL-10 (IP-10), CCL-2 (MCP-1), CXCL-9 (MIG), CCL-3 (MIP-1α), CCL-4 (MIP-1β), CCL-5, TNF-α, Eotaxin, IL-21 and IL-23) in culture supernatants using Luminex and ELISA:

We used a multivariate analysis in order to identify a signature that discriminate active and inactive TA patients. The multivariate analysis used a Student test associated with Benjamini-Hochberg correction (q-value<0.05). Flow cytometric analysis of peripheral blood mononuclear cells was performed for cell surface markers, intracellular production of cytokines and FoxP3 expression. Artery biopsies from 3 TA patients and 3 controls were tested by immunohistochemistry.

Multivariate analysis identified a cytokine signature comprised of 9 cytokines discriminating active and inactive TA patients with positive and negative predictive values of 100% and 95%, respectively.

We identified an immunological signature that discriminates active and inactive Takayasu arteritis patients with high sensitivity and specificity. Cytokine measurement, FACS and immunochemistry analyses suggest the major role of Th1, Th17 and IL-21 in the pathogenesis of TA. IL-21 exerts a critical role in modulating Th1 and Th17 responses and regulatory T cells in TA, and might represent a potential target for novel therapy.

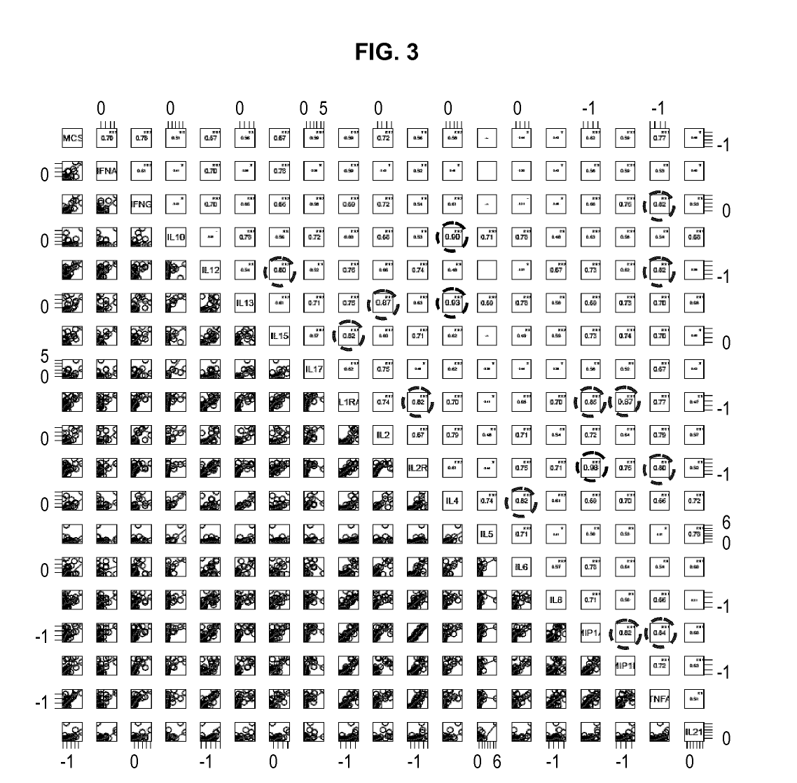

FIG. 3 illustrates Pearson correlation coefficients rₚ between differentially expressed cytokines. Among the 26 tested cytokines and chemokines, 16 were significantly differentially expressed between both groups. The stepwise withdrawal of highly correlated cytokines on the basis of their Pearson correlation coefficients allowed us to reduce this selection to a 9 cytokine signature which discriminates patients into two groups according to their disease status. On FIG. 3, Pearson coefficients rₚ>0.9 and Pearson coefficients rₚ>0.8 have been circled.

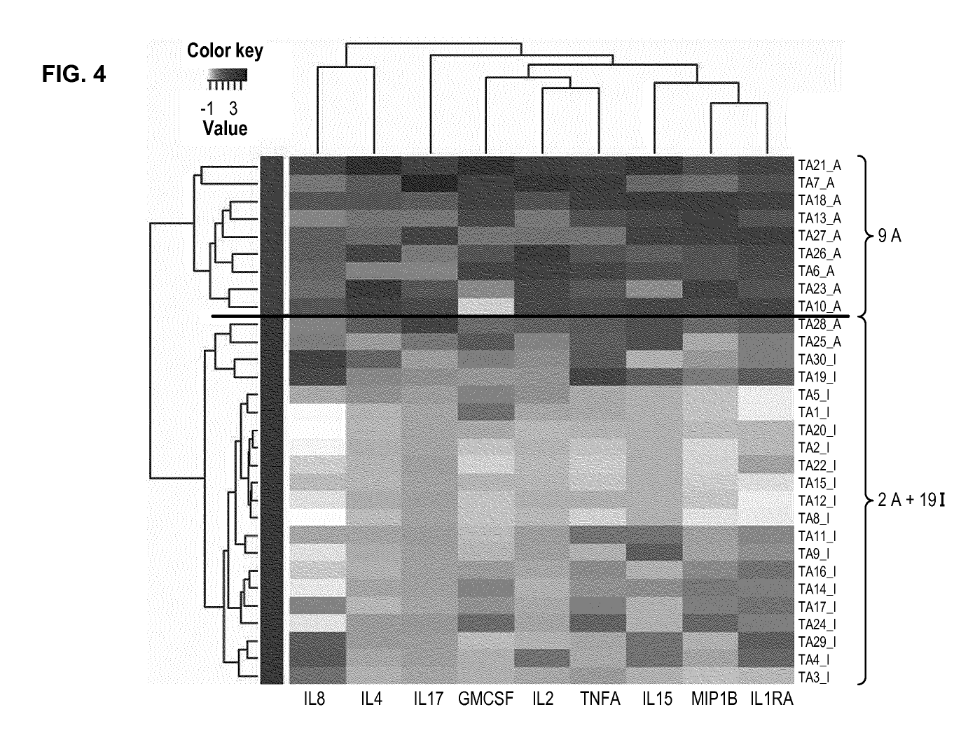

FIG. 4 illustrates a hierarchical classification on signatures obtained for the 30 patients of the reference population. The reference population is comprised of 11 patients presenting active disease (noted A) and 19 patients presenting disease in remission (noted I). The signal values follow the color code indicated by the scale. The colorized vertical band identifies the cluster of sample obtained. The immunological signature involves 9 cytokines/chemokines: IL-1RA, IL-2, IL-4, IL-8, IL15, IL-17, TNF-α, GM-CSF and MIP-1β.

Table 2 summarizes the accuracy indexes calculated on the predictive function.

TABLE 2

| | Prediction | | | | |
|---|---|---|---|---|---|
| | error rate | SE | SP | PPV | NPV |
| Takayasu | 3% | 91% | 100% | 100% | 95% |

SE: Sensitivity, SP: Specificity, PPV: Positive Predictive Value, NPV: Negative Predictive Value

### Example 2

### Giant Cell Arteritis (Horton Disease)

Giant cell arteritis is a systemic autoimmune disorder that typically affects medium and large arteries, usually leading to occlusive granulomatous vasculitis with transmural infiltrate containing multinucleated giant cells. The temporal artery is commonly involved. This disorder appears primarily in people over the age of 50. We used a multivariate analysis in order to identify an immunological signature that help to discriminate patients with active and inactive Giant cell arteritis. The multivariate analysis used a Student test associated with Benjamini-Hochberg correction (q-value<0.05).

A dataset of 26 cytokine and chemokine levels was available for a cohort of 30 patients presenting active disease (14 A) or disease in remission (16 I).

We measured levels of 26 cytokines (GM-CSF, IFN-α, IFN-γ, IL-1RA, IL1β, IL-2, IL-2r, IL-4, IL-5, IL-6, IL-7, IL-8, IL-10, IL-12, IL-13, IL-15, IL-17, CXCL-10 (IP-10), CCL-2 (MCP-1), CXCL-9 (MIG), CCL-3 (MIP-1α), CCL-4 (MIP-1β), CCL-5, TNF-α, Eotaxin IL-21 and IL-23) in culture supernatants using Luminex and ELISA.

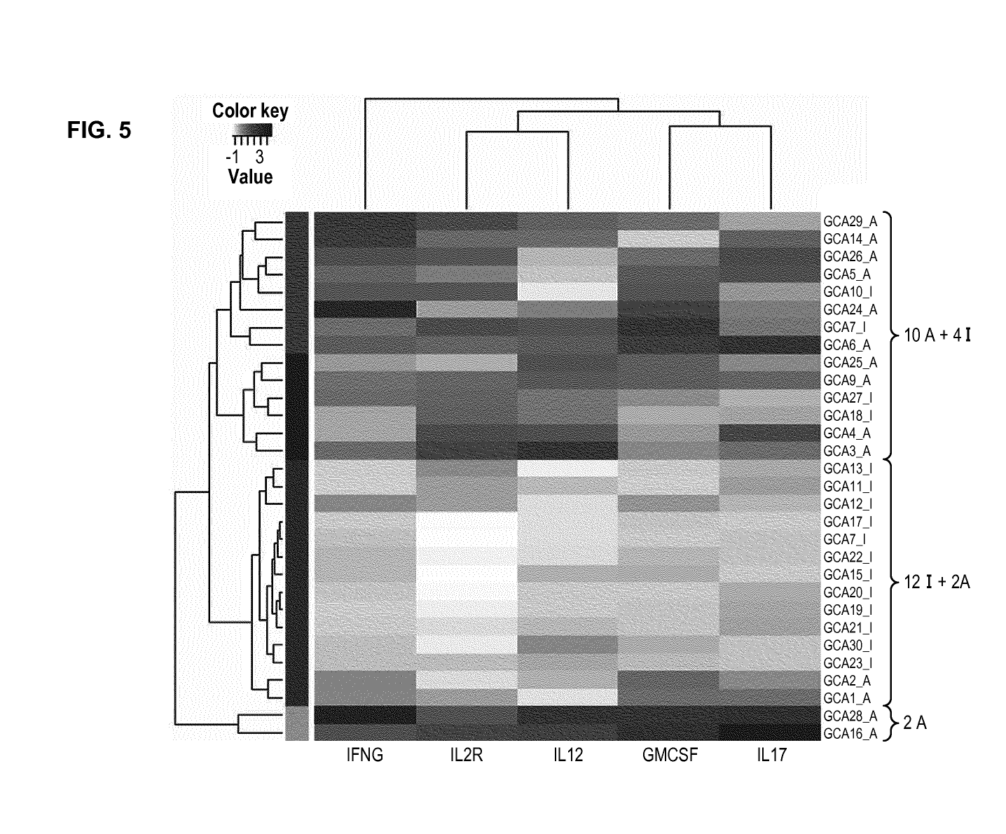

FIG. 5 illustrates a hierarchical classification on signatures obtained for the 30 patients of the reference population. The reference population is comprised of 14 patients presenting active disease (noted A) and 16 patients presenting disease in remission (noted I). The signal values follow the color code indicated by the scale. The colorized vertical band identifies the cluster of sample obtained. The immunological signature involves 5 cytokines: IL-2r, IL-12, IFN-γ, IL-17 and GM-CSF.

Table 3 summarizes the accuracy indexes calculated on the predictive function built from this signature.

TABLE 3

| | Prediction | | | | |
|---|---|---|---|---|---|
| | error rate | SE | SP | PPV | NPV |
| Horton | 13% | 79% | 94% | 92% | 83% |

SE: Sensitivity; SP: Specificity; PPV: Positive Predictive Value; NPV: Negative Predictive Value.

### Cross-Validation

In order to validate the specificity of the obtained signatures, a cross validation was performed using the signature obtained for a first pathology on the dataset of a second pathology and vice-versa.

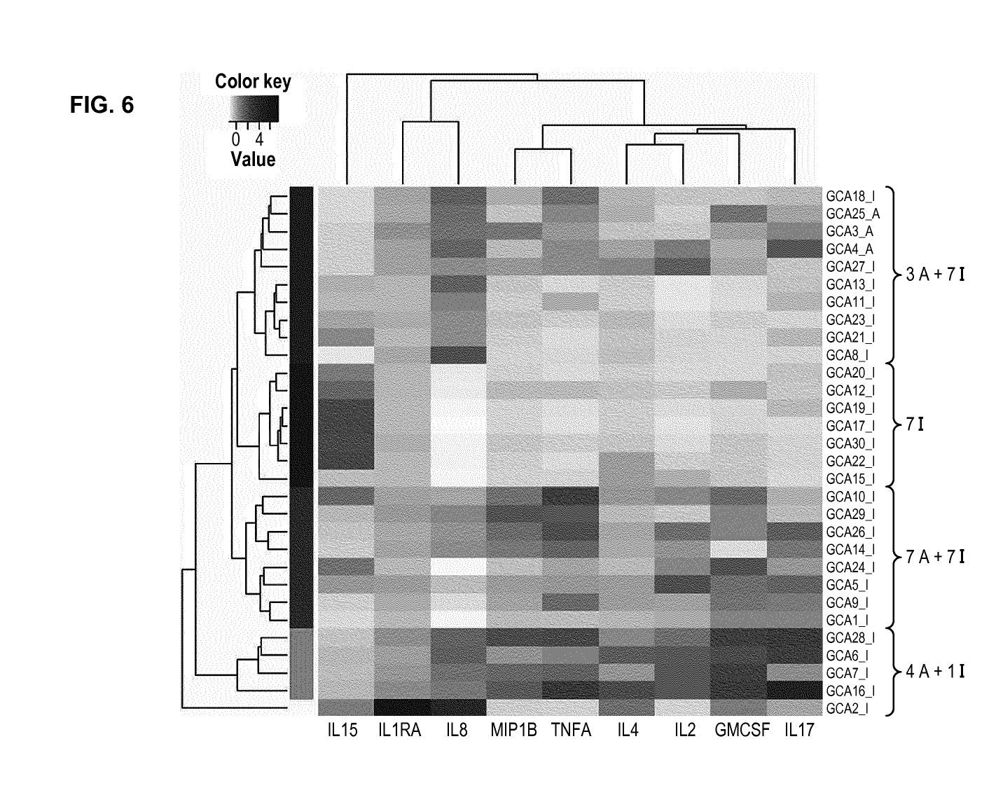

For example, FIG. 6 shows the hierarchical clustering obtained when Takayasu signature is applied to Horton patient dataset.

Table 4 summarizes the accuracy indexes calculated on the predictive function built from this signature.

TABLE 4

| | Prediction | | | | |
|---|---|---|---|---|---|
| | error rate | SE | SP | PPV | NPV |
| Horton | 23% | 64% | 88% | 82% | 74% |

SE: Sensitivity; SP: Specificity; PPV: Positive Predictive Value; NPV: Negative Predictive Value.

As expected, the Takayasu signature is less powerful on Horton dataset than it is on the original dataset; the prediction error rate is much higher and the SE, SP, PPV and NPV indexes lower. Although the two diseases are related, this result establishes the level of specificity of the Takayasu signature.

### Example 3

### Sporadic Inclusion Body Myositis

Sporadic Inclusion Body Myositis (sIBM) is an inflammatory myopathy characterized by CD8+ cytotoxic infiltrates and amyloid deposits. Regulatory T cells (Treg) are key regulators of immune response.

A dataset of 25 cytokines and chemokines levels was available for a cohort of 22 patients presenting active disease (22 sISBM) or controls (22 ctrls).

Quantitative determination of 25 cytokines or chemokines (GM-CSF, IFN-α, IFN-γ, IL-1RA, IL1β, IL-2, IL-2r, IL-4, IL-5, IL-6, IL-7, IL-8, IL-10, IL-12, IL-13, IL-15, IL-17, CXCL-10 (IP-10), CCL-2 (MCP-1), CXCL-9 (MIG), CCL-3 (MIP-1α), CCL-4 (MIP-1β), CCL-5 (RANTES), TNF-α and Eotaxin) was performed in sera and in supernatant of culture, using Human Cytokine 25-Plex (Invitrogen, Cergy Pontoise, France) in accordance with the manufacturer protocol. We used a multivariate analysis in order to identify a signature that discriminate active sIBM patients and controls. The multivariate analysis used a Student test associated with Benjamini-Hochberg correction (q-value<0.05).

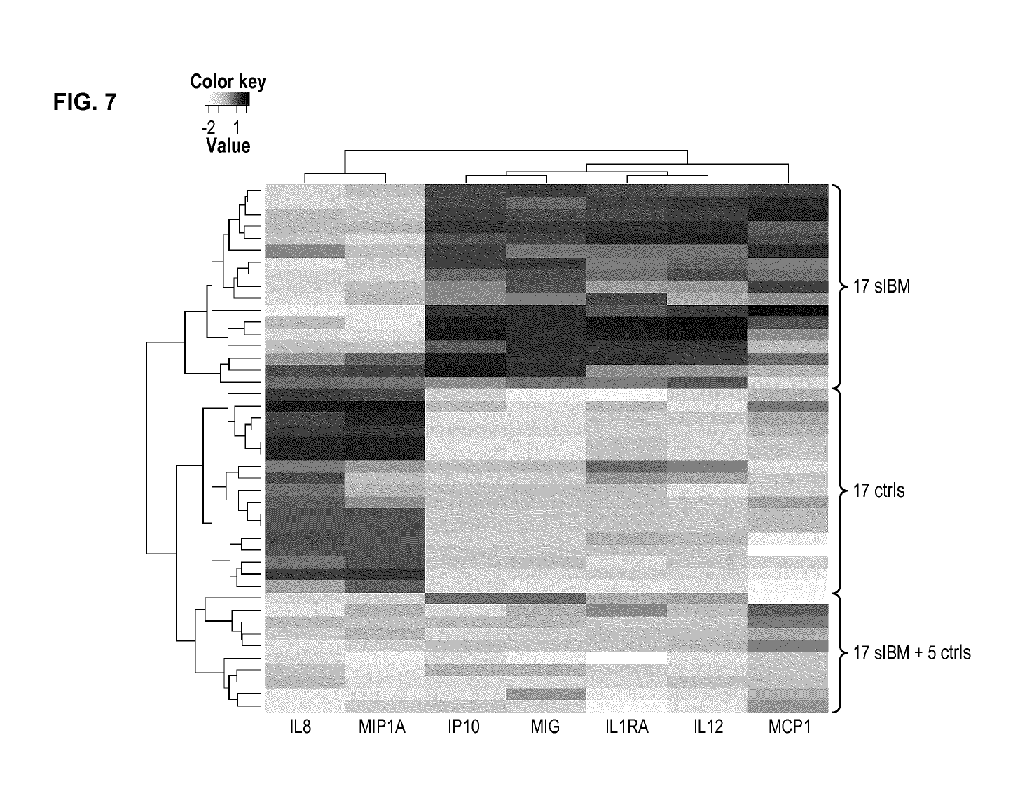

FIG. 7 illustrates a hierarchical classification on a signature obtained for the 44 patients of the reference population. The reference population is comprised of 22 patients presenting active disease (noted sIBM) and 22 patients presenting inactive disease (noted ctrls). The signal values follow the color code indicated by the scale. The colorized vertical band identifies the cluster of sample obtained. The immunological signature involves 7 cytokines/chemokines: IL-1 RA, IL-8, IL-12, CCL-2 (MCP-1), CCL-3 (MIP-1α), CXCL-9 (MIG), and CXCL-10 (IP-10).

### Example 4

### Behçet's Disease

A dataset of 26 cytokine and chemokine levels was available for a cohort of 65 individuals: 20 healthy donors (HD) and 45 Behçet's disease (BD) patients presenting active disease (20 A) or disease in remission (25 I). Following the method described previously and using Student test associated with Benjamini-Hochberg correction (q-value<0.05), only one is identified as differentially expressed between HD and BD patients. However, when BD patients are separated according to their activity status, 4 cytokines are identified as differentially expressed, using ANOVA (ANalysis Of VAriance) test, between the three groups (IL-17, TNF-A, IL-23 and IL-21). Among these four, two cytokines are significant between active BD (BehA) and HD, 1 between inactive BD (BehI) and HD and none between both BD subsets as shown in Table 5.

TABLE 5
Statistical significance for each comparison.

| FDR <0.05 | IL17 | IL1RA | TNFA | IL23 | IL21 | # |
|---|---|---|---|---|---|---|
| ANOVA | 2.E−02 | 2.E−01 | 3.E−02 | 2.E−02 | 4.E−02 | 4 |
| HD vs Beh | 1.E+00 | 1.E+00 | 1.E+00 | 2.E−02 | 1.E+00 | 1 |
| HD vs BehA | 3.E−01 | 2.E−02 | 4.E−01 | 4.E−02 | 3.E−01 | 2 |
| HD vs BehI | 1.E+00 | 1.E+00 | 1.E+00 | 1.E−02 | 1.E+00 | 1 |
| BehA vs BehI | 3.E−01 | 4.E−01 | 1.E−01 | 1.E+00 | 3.E−01 | 0 |

HD: healthy donors;
Beh: Behçet's disease patients.
BehA: Behçet's disease active patients;
BehI: Behçet's disease inactive patients;
q-value (FDR) <0.05.

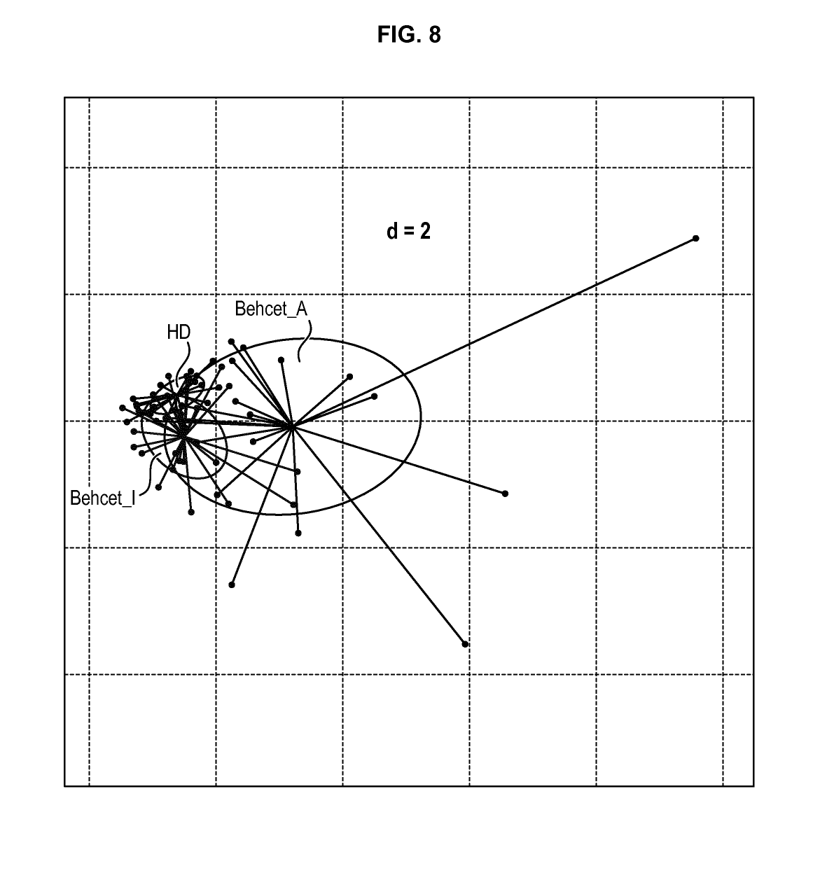

FIG. 8 is a diagram illustrating the Principal Component Analysis (PCA) projection of the samples using the 4 cytokines selected by ANOVA. Samples are projected according to the first two components (capturing 53.7% and 21.7% of the total variability, respectively). In FIG. 8, Behcet_A refers to Behçet's disease active patients, Behcet_I refers to Behçet's disease inactive patients, HD refers to healthy donors.

The projection of the samples according to the first two PCA components shows that “HD” and “Behcet_I” groups overlap while the Behcet_A” group is apart. However, this separation is not clear and an overlap is observable due to large sampling variability “Behcet_A”.

The high variability within BD patients does not allow to discriminate them according to the group they were labelled in. It seems that the cohort should be divided into more subgroups to ensure an internal variability. Indeed, BD is a complex syndrome with a lot of symptoms, thus the group definition might not be accurate.

### Example 5

### Hepatitis C Virus (HCV)

Data were collected for 155 HCV patients divided into 4 groups:

| | |
|---|---|
| Group 0 = Cryo[globulin] negative] (HCV+Cryo−) | N = 57 |
| Group 1 = Cryo asymptomatic (HCV+Cryo+) | N = 17 |
| Group 2 = Cryo with vascularitis (HCV+Cryo+Vasc+) | N = 62 |
| Group 3 = Cryo with lymphoma (HCV+Cryo+NHL+) | N = 19 |
| (NHL refers to Non-Hodgkin Lymphoma) | |

The dataset is composed by 8 biological measurements:

| | |
|---|---|
| CD137 | C4 complement |
| CD22 | Gammaglobulines |
| CD27 | HIgM_Kappa/HIgM_Lambda |
| IL-2R | Ratio Kappa/Lambda |

Following the method described previously and using a Student test associated with Benjamini-Hochberg correction (q-value<0.01), it has been showed that Cryo⁻ NHL⁻ and asymptomatic Cryo⁺ NHL⁻ patients (groups 0, 1) are slightly similar, since only one factor (C4) is significantly different between them, but both groups are distinct from HCV⁺Cryo⁺Vascu⁺ patients (group 2). As summarised in Table 6, the no lymphoma (groups 0, 1, 2) vs. lymphoma (group 3) comparison identified a signature of 4 biological markers (CD27, Gglob, IL2R, C4) strongly differentially expressed which discriminated patients.

TABLE 6
Statistical significance of all factors for each comparison.

| | CD22 | CD27 | RatioKL | Gglob | RatioHIgM | IL.2R | C4 | # q < 0.01 |
|---|---|---|---|---|---|---|---|---|
| 0 vs 1 | | | | | | | ** | 1 |
| 0 vs 2 | ** | ** | ** | * | ** | ** | ** | 6 |
| 1 vs 2 | * | * | ** | ** | ** | ** | ** | 5 |
| 0 vs 3 | ** | ** | * | ** | * | ** | ** | 5 |
| 1 vs 3 | * | ** | * | ** | * | ** | ** | 4 |
| 2 vs 3 | | * | | ** | | ** | ** | 3 |
| no lymp. vs | * | ** | * | ** | * | ** | ** | 4 |
| lymph. | | | | | | | | |

Each of the four groups of patients was compared to the others.
Patients NLH− (no lymphoma) were gathered and compared to patients NHL+ with lymphoma.
*: q-value <0.05;
**: q-value <0.01

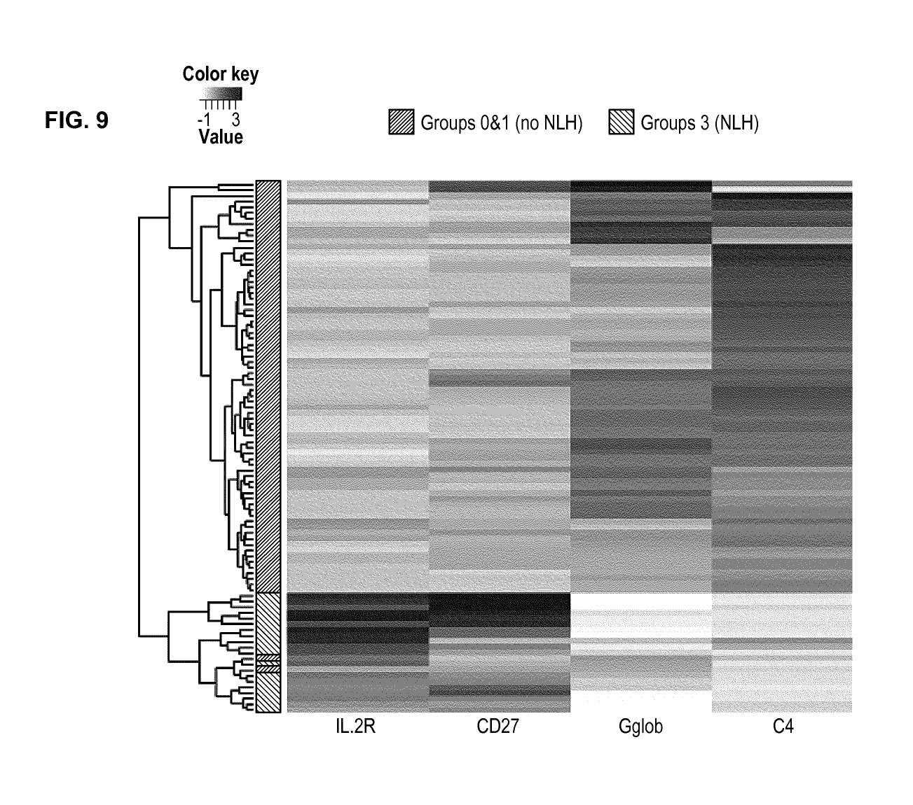

FIG. 9 illustrates a hierarchical classification on signatures obtained for the 155 patients of the reference population. The reference population is comprised of 57 Cryo[globulin] neg[ative] patients (noted HCV+FCryo−), 17 Cryo asymptomatic patients (HCV+Cryo+), 62 Cryo with vascularitis patients (HCV+Cryo+Vasc+) and 19 Cryo with lymphoma patients (HCV+FCryo+NHL+). The signal values follow the color code indicated by the scale. The colorized vertical band identifies the cluster of sample obtained. The immunological signature involves 4 biological markers: CD27, Gglob, IL2R, C4.

Since HCV+Cryo+Vascu+ patients showed a high internal variability, only HCV+Cryo− and HCV+Cryo+ patients were used as NHL− group to build the predictive model. The LDA coefficients obtained are summarised in Table.

TABLE 7
LDA coefficients associated to each factor of the model
using data from groups 0, 1 and 3

| LDA | CD27 | Gglob | IL2R | C4 |
|---|---|---|---|---|
| coeff | 0.2714163 | −0.609829 | 0.931996 | −0.739886 |

In order to assess the prediction accuracy of the resulting LDA model, two internal validation techniques were used: the Leave-One-Out (LOO) cross-validation and the bootstrap. The LOO approach is a stepwise procedure against each response variable (clinical groups) which uses iteratively (N−1) patients for the model development (with N, the total number of patients) and the patient who was left out for the validation. For the bootstrap approach, 1000 datasets were simulated by drawing with replacement 100 samples from the original dataset. Using the selected biological markers, a LDA model were built for each bootstrap dataset and validated in the original dataset.

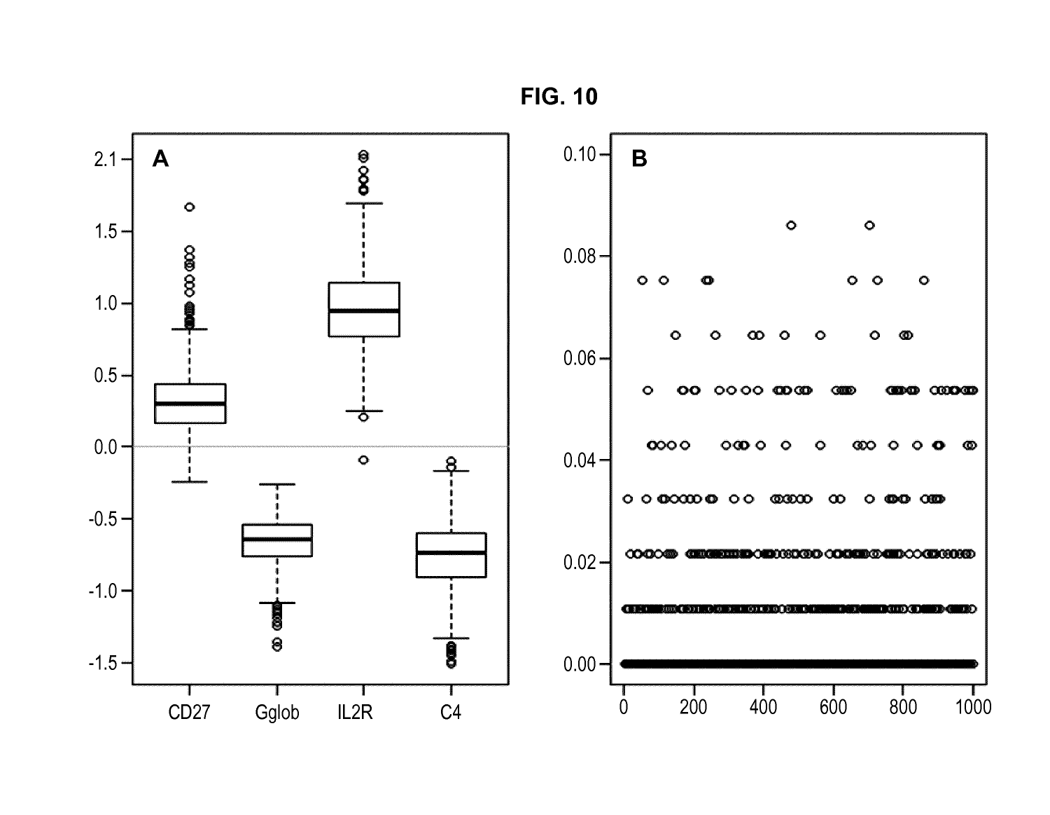

FIG. 10 shows the distribution of the four LDA coefficients among the 1000 bootstrap iterations. The LOO cross-validation of the original model led to a prediction error rate of 0%. In addition, among the 1000 iteration processed by bootstrap, the prediction error varies between 0 and 8.6%.

Finally, the predictive model was used to predict the pathological status of HCV+Cryo+Vascu+ patients. Among the 62 patients, 20 were predicted as NLH+.

1. A method for determining a predictive function for discriminating patients according to their disease activity status, comprising steps of:
a—measuring values of biological markers for each patient of a first group of patients having a first known disease activity status, and for each patient of a second group of patients having a second known disease activity status, the measured values forming a dataset
b—analyzing the dataset for identifying biological markers which are differentially expressed between the first group of patients and the second group of patients,
c—among the biological markers identified at step b, determining correlated markers as markers which are correlated with other markers above a predetermined significance level,
d—removing from the dataset, values measured for a biological marker identified as correlated marker,
e—analyzing the dataset obtained at step d for determining a predictive function that predicts a disease activity status of a patient as a combination of values of biological markers,
f—evaluating an accuracy index associated with the predictive function determined at step e,
g—repeating steps d to f by selectively removing from the dataset, values measured for one or several biological marker(s) identified as correlated marker(s), so as to gradually decrease the number of biological markers in the combination of value until the accuracy index reaches an expected level.

2. The method according to claim 1, comprising step of:
h—replacing missing values by default values in the dataset before carrying out step b.

3. The method as defined in claim 2, wherein step h is performed for each biological marker having less than a predetermined rate of missing values per group.

4. The method according to claim 2, wherein for a given biological marker, default values are randomly drawn from a uniform distribution comprised between 0 and a detection threshold associated with measurement of the biological marker.

5. The method according to claim 1, comprising a step of:
i—normalizing the measured values of the dataset, so that step b is carried out on a normalized dataset.

6. The method according to claim 5, wherein step i is performed by subtracting a mean value to the value to be normalized and dividing by a standard deviation, the mean value and the standard deviation being determined for each group of patients.

7. The method according to claim 5, wherein the values of the dataset are log 10 transformed before normalization.

8. The method according to claim 1, wherein step b comprises:
j—applying a statistical test to the dataset for determining, for each biological marker, a probability that, given the dataset, the biological marker is found to be differentially expressed while not differentially expressed between the two groups of patients,
k—selecting biological markers having a probability equal or lower than the predetermined significance level.

9. The method according to claim 8, wherein step b also comprises:
l—applying a false discovery rate correction to each probability and carrying out step k on each corrected probability associated with a given biological marker.

10. The method according to claim 8, wherein the statistical test is a parametric test such as a Student test.

11. The method according to claim 8, wherein at step l, each corrected probability is obtained by applying Benjamini-Hochberg False Discovery Rate correction to each probability.

12. The method according to claim 1, wherein the predictive function is a linear combination of values of the biological markers.

13. The method according to claim 12, wherein step e is performed by Linear Discriminant Analysis of the dataset obtained at step d.

14. The method according to claim 1, wherein the accuracy index associated with a predictive function is obtained by using a Leave-One-Out cross-validation method.

15. The method according to claim 1, wherein the accuracy index is derived from a prediction error rate, a sensitivity, a specificity, a positive predictive value and/or a negative predictive value associated with the predictive function determined at step e.
